(19) United States
(12) Patent Application Publication
(10) Pub. No.: US 2019/0225144 A1
(43) Pub. Date: Jul. 25, 2019

(54) NOTIFICATION APPARATUS

(71) Applicants: AutoNetworks Technologies, Ltd., Yokkaichi, Mie (JP); Sumitomo Wiring Systems, Ltd., Yokkaichi, Mie (JP); Sumitomo Electric Industries, Ltd., Osaka (JP)

(72) Inventors: Yuji TAKENAKA, Yokkaichi, Mie (JP); Daisuke SAKAI, Yokkaichi, Mie (JP)

(21) Appl. No.: 16/314,810

(22) PCT Filed: Jun. 15, 2017
(86) PCT No.: PCT/JP2017/022062

§ 371 Date: Jan. 2, 2019

(30) Foreign Application Priority Data
Jul. 5, 2016 (JP) 2016-133559

(51) Int. Cl. B60Q 3/70; B60Q 3/217; B60Q 3/50; B60R 25/34

(52) U.S. Cl. CPC B60Q 3/70; B60R 25/34; B60Q 3/50; B60Q 3/217

(57) ABSTRACT

Provided is a notification apparatus that is capable of notifying an occupant of an open/closed state of a vehicle door, from both the inside and the outside of the vehicle. The notification apparatus is a notification apparatus provided in a vehicle, including: an interior light configured such that some light emitted therefrom passes through a window of the vehicle; a detection unit that detects an open/closed state of a door of the vehicle; and a control unit that performs lighting control on the interior light such that the interior light emits light in a lighting mode corresponding to a result of detection by the detection unit. The notification apparatus notifies an occupant in and/or out of the vehicle, of the open/closed state of the door, using light emitted from the interior light.

### CROSS-REFERENCE TO RELATED APPLICATIONS

This application is the U.S. national stage of PCT/JP2017/022062 filed Jun. 15, 2017, which claims priority of Japanese Patent Application No. JP 2016-133559 filed Jul. 5, 2016.

### TECHNICAL FIELD

The present disclosure relates to a notification apparatus.

### BACKGROUND

There is a conventional system that detects an open/closed state of doors of a vehicle, and notifies an occupant of the result of detection. For example, JP 2002-240625A discloses an automobile door visor, wherein the rear end surface of an eave portion of the automobile door visor is provided with a light-emitting diode, and the automobile door visor informs an occupant, who has got out of the automobile, that a door is improperly closed, or informs a following automobile that a door has opened, by lighting up the light-emitting diode.

However, the automobile door visor disclosed in JP 2002-240625A is configured to notify an occupant outside the vehicle of an open/closed state of a vehicle door by lighting up the light-emitting diode provided on the rear end surface of the eave portion, and there is a problem in which an occupant inside the vehicle cannot see the light-emitting diode, and an occupant who has already got into the vehicle cannot confirm an open/closed state of the vehicle door. In addition, there is also a problem in which an occupant who has got out of the vehicle from a seat on the driver's seat side (the driver's seat or the seat behind the driver's seat) cannot see the light-emitting diode provided on the door visor on the side opposite the driver's seat (the passenger's seat side), and cannot confirm an open/closed state of a vehicle door on the passenger's seat side.

The present disclosure has been made in view of such a situation, and aims to provide a notification apparatus that is capable of notifying an occupant of an open/closed state of a vehicle door, from both the inside and the outside of the vehicle.

### SUMMARY

A notification apparatus according to one aspect of the present application is a notification apparatus provided in a vehicle, the notification apparatus including: an interior light configured such that some light emitted therefrom passes through a window of the vehicle; a detection unit that detects an open/closed state of a door of the vehicle; and a control unit that performs lighting control on the interior light such that the interior light emits light in a lighting mode corresponding to a result of detection by the detection unit. The notification apparatus notifies an occupant in and/or out of the vehicle, of the open/closed state of the door, using light emitted from the interior light.

### Advantageous Effects of Disclosure

According to the present disclosure, it is possible to notify an occupant of an open/closed state of a vehicle door, from both the inside and the outside of the vehicle.

### BRIEF DESCRIPTION OF DRAWINGS

FIG. 1 is a schematic diagram illustrating an overall configuration of a notification system according to a first embodiment.

FIG. 2 is a diagram illustrating an example of an arrangement of interior lights.

FIG. 3 is a diagram illustrating an example of an arrangement of the interior lights.

FIG. 4 is a block diagram illustrating a configuration of a control system of the notification system according to the first embodiment.

FIG. 5 is a flowchart illustrating processing procedures performed by a body ECU according to the first embodiment.

FIG. 6 is a diagram illustrating an example of lighting in a case where the driver is already in the vehicle and a vehicle door has been properly opened and closed.

FIG. 7 is a diagram illustrating an example of lighting in a case where a vehicle door has not been properly closed.

FIG. 8 is a diagram illustrating an example of lighting in a case where the vehicle doors have been properly opened and closed when occupants have got out of the vehicle.

FIG. 9 is a diagram illustrating an example of lighting in a case where a vehicle door has not been properly closed.

FIG. 10 is a diagram illustrating an example of an arrangement of the interior lights.

### DETAILED DESCRIPTION OF PREFERRED EMBODIMENTS

The following lists up and describes embodiments of the present disclosure. At least parts of the embodiments described below may be combined in any manner.

A notification apparatus according to one aspect of the present disclosure is a notification apparatus provided in a vehicle, the notification apparatus including: an interior light configured such that some light emitted therefrom passes through a window of the vehicle; a detection unit that detects an open/closed state of a door of the vehicle; and a control unit that performs lighting control on the interior light such that the interior light emits light in a lighting mode corresponding to a result of detection by the detection unit. The notification apparatus notifies an occupant in and/or out of the vehicle, of the open/closed state of the door, using light emitted from the interior light.

According to the above-described aspect, an occupant can confirm the open/closed state of the door by checking the lighting state of the interior light, both when the occupant is sitting on a seat in the vehicle and when the occupant has got out of the vehicle.

In a notification apparatus according to one aspect of the present disclosure, the open/closed state of the door detected by the detection unit includes an open state in which the door is open and a closed state in which the door is closed, and the control unit changes the lighting mode of the interior light depending on whether the detection unit detects the open state or the closed state of the door.

With the above-described one aspect, an occupant can determine whether the door is in an open state or a closed state by checking the lighting state of the interior light.

In a notification apparatus according to one aspect of the present disclosure, the open/closed state of the door detected by the detection unit includes an open state in which the door is open, a closed state in which the door is fully closed, and an improperly closed state that is a state between the open state and the closed state, and the control unit changes the lighting mode of the interior light depending on whether the detection unit detects the open state, the closed state, or the improperly closed state of the door.

With the above-described one aspect, an occupant can determine whether the door is in an open state, a closed state, or an improperly closed state by checking the lighting state of the interior light.

In the notification apparatus according to one aspect of the present disclosure, the interior light is provided for each of a plurality of doors of the vehicle, and the control unit performs lighting control on the interior lights such that the interior lights emit light in different lighting modes according to detection results regarding the respective open/closed states of the doors.

With the above-described one aspect, it is possible to determine the respective open/closed states of the doors by checking the respective lighting states of the interior lights.

In the notification apparatus according to one aspect of the present disclosure, the interior light is arranged such that the light emitted therefrom passes through a plurality of windows that face each other in a width direction of the vehicle.

With the above-described one aspect, an occupant can confirm the open/closed state of the door that is opposite the door from which the occupant has got out of the vehicle, by checking the interior light.

In the notification apparatus according to one aspect of the present disclosure, the interior light is arranged at the lower end of the inner side of a window opening portion of the door.

With the above-described one aspect, it is unnecessary for an occupant to look up to check the interior light. Therefore, it is less likely that the direction of sight coincides with the direction of sunlight, and the occupant can favorably check the interior light.

In the notification apparatus according to one aspect of the present disclosure, the window is constituted by a light-transmitting member provided with a first light-transmitting region that is provided at the lower end of the window and a second light-transmitting region that has lower transmittance than the first light-transmitting region and is provided above the first light-transmitting region, and the interior light is arranged so as to face the first light-transmitting region.

With the above-described one aspect, even if a light-transmitting member with low transmittance, such as a pane of privacy glass, is used, the notification apparatus can notify an occupant who has got out of the vehicle, of the open/closed state of the door, using light that passes through the first light-transmitting region provided at the lower end of the light-transmitting member.

In the notification apparatus according to one aspect of the present disclosure, the lighting mode relates to the color of light, the brightness thereof, and the timing of turning the interior light ON and OFF.

With the above-described one aspect, the notification apparatus can notify an occupant of the open/closed state of the door by changing the lighting mode by using the color of light emitted by the interior light, the brightness thereof, and the timing of turning the interior light ON and OFF.

The following specifically describes the present disclosure with reference to the drawings showing the embodiments of the present disclosure.

### First Embodiment

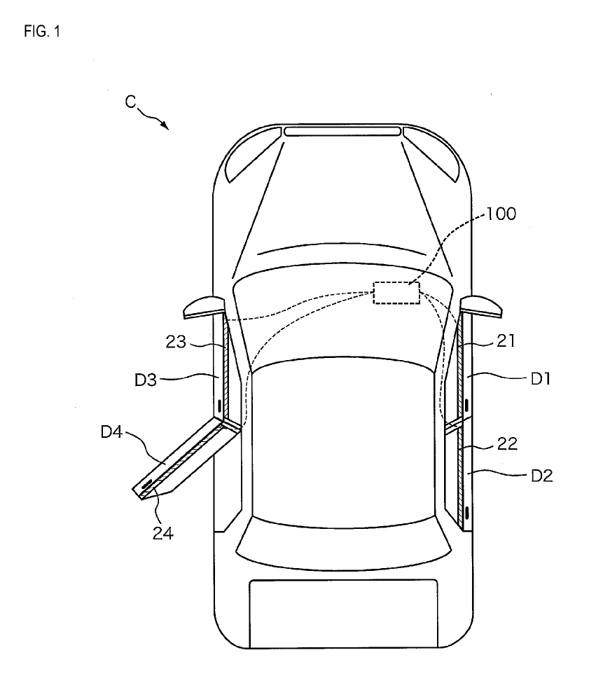

FIG. 1 is a schematic diagram illustrating an overall configuration of a notification system according to a first embodiment. The notification system according to the first embodiment is a system by which an occupant in and/or out of the vehicle C is notified of open/closed states of vehicle doors D1 to D4. The notification system includes a body ECU (Electronic Control Unit) 100 provided inside the vehicle C and interior lights 21 to 24 that are subjected to lighting control performed by the body ECU 100.

The present embodiment describes a configuration in which the vehicle C is provided with four vehicle doors, namely the vehicle door D1, which is for the driver's seat, the vehicle door D2, which is for the right rear seat (the seat behind the driver's seat), the vehicle door D3, which is for the passenger's seat, and the vehicle door D4, which is for the left rear seat (the seat behind the passenger's seat). However, the number of vehicle doors that the vehicle C is provided with is not limited to four.

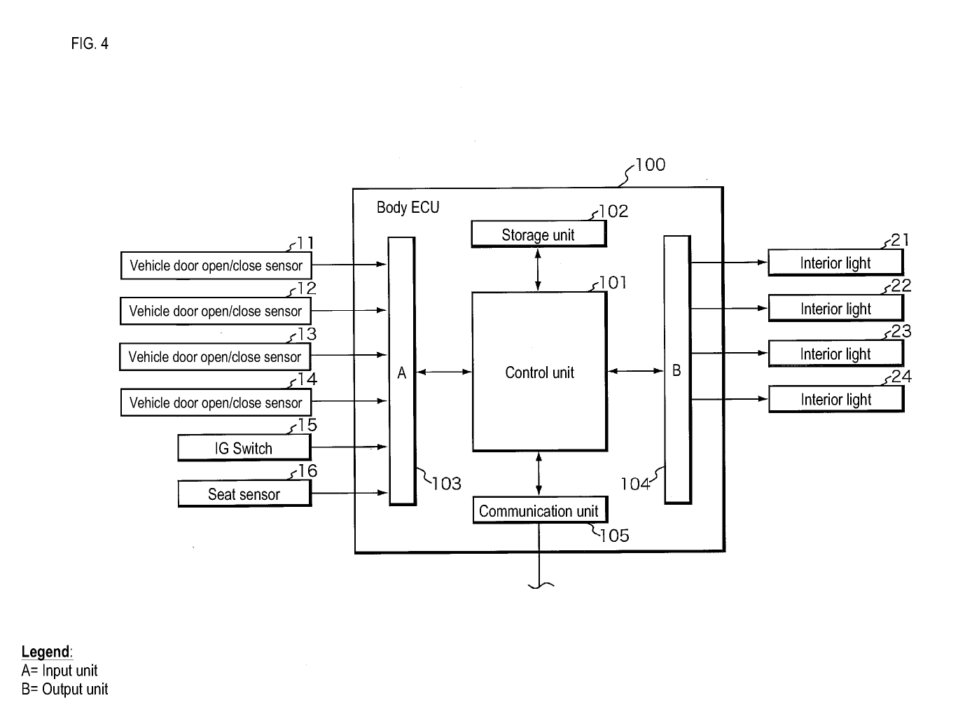

The body ECU 100 acquires a detection result from a detection unit (vehicle door open/close sensors 11 to 14 described below: see FIG. 4) that detects the open/closed states of the vehicle doors D1 to D4, and performs lighting control on the interior lights 21 to 24 in a lighting mode corresponding to the open/closed states of the vehicle doors D1 to D4.

The interior lights 21 to 24 are light-emitting apparatuses provided with LEDs (Light Emitting Diodes), for example, and are configured to be turned ON and OFF under lighting control performed by the body ECU 100. Note that the interior lights 21 to 24 may each be constituted by a plurality of LEDs lined up on a substrate that is elongated in one direction, and configured to emit light in a linear shape, or configured to diffuse light emitted from an LED, using a light-guide plate, and emit light in a band shape. Also, the interior lights 21 to 24 may each be configured to emit light in a dot shape or any shape using one or more LEDs.

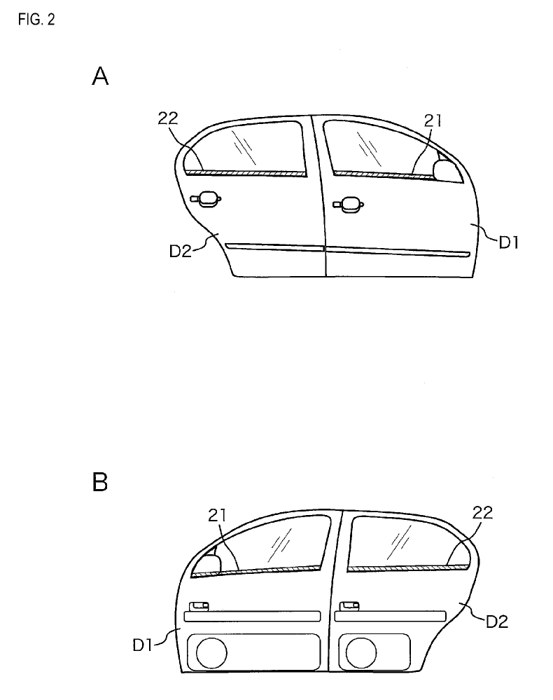

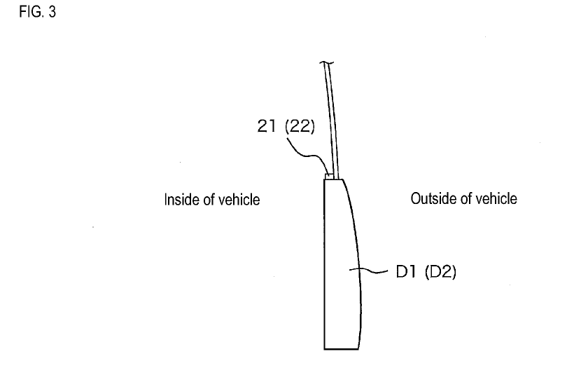

The interior lights 21 to 24 are respectively arranged at lower ends of window opening portions of the vehicle doors D1 to D4, for example. FIGS. 2 and 3 illustrate an example of an arrangement of the interior lights 21 to 24. FIG. 2A is a front view of the vehicle doors D1 and D2 seen from the outside of the vehicle, and FIG. 2B is a rear view of the vehicle doors D1 and D2 seen from the inside of the vehicle. FIG. 3 is a partially enlarged view of the vehicle door D1 (D2) seen in the thickness direction.

As shown in FIG. 2A, the interior lights 21 and 22 are rod-shaped or band-shaped light sources, for example, and are respectively arranged along the lower ends of window opening portions of the vehicle doors D1 and D2. Therefore, when the interior lights 21 and 22 are turned ON, an occupant can confirm a lighting state from the outside of the vehicle. Also, as shown in FIG. 3, the interior light 21 (22) is arranged at the lower end of the inner side of the window opening portion of the vehicle door D1 (D2). Therefore, even when sitting in the vehicle, an occupant can visually confirm the lighting state of the interior light 21 (22). Furthermore, as a result of the interior lights 21 and 22 being arranged as described above, light emitted from the interior lights 21 and 22 passes through the windows of the vehicle doors D3 and D4 that are opposite the vehicle door D1 (D2) in the vehicle width direction. Therefore, even if an occupant gets out of the vehicle from the vehicle door D3 or D4 on the passenger's seat side, the occupant can visually confirm the lighting state of the interior lights 21 and 22.

Although the interior lights 21 and 22 arranged on the right side surface of the vehicle C are described with reference to FIGS. 2 and 3, the same description applies to the interior lights 23 and 24 arranged on the left side surface of the vehicle C.

FIG. 4 is a block diagram illustrating a configuration of a control system of the notification system according to the first embodiment. The body ECU 100 includes, for example, a control unit 101, a storage unit 102, an input unit 103, an output unit 104, and a communication unit 105.

The control unit 101 includes, for example, a CPU (Central Processing Unit), a ROM (Read Only Memory), and a RAM (Random Access Memory). The CPU in the control unit 101 executes a control program stored in the ROM, thereby realizing, for example, the function of controlling operations of the above-described pieces of hardware provided in the body ECU 100 to perform lighting control on the interior lights 21 to 24 such that the interior lights 21 to 24 emit light in a lighting mode corresponding to the open/closed states of the vehicle doors D1 to D4. The RAM in the control unit 101 temporarily stores, for example, data while the control program is being executed. Note that the control unit 101 may have, for example, the function of a timer that measures a period of time that has elapsed from when a measurement start instruction is given to when a measurement stop instruction is given, and the function of a counter that counts.

The storage unit 102 is constituted by, for example, a non-volatile memory such as an EEPROM (Electronically Erasable Programmable Read Only Memory), and stores, for example, information regarding lighting control that is to be performed on the interior lights 21 to 24.

The input unit 103 is provided with an interface for connecting the vehicle door open/close sensors 11 to 14, an ignition switch 15 (hereinafter denoted as the “IG switch 15”), a seat sensor 16, and so on thereto. Upon acquiring detection results output from the vehicle door open/close sensors 11 to 14, a switch state output from the IG switch 15, a detection result output from the seat sensor 16, and so on, the input unit 103 outputs the acquired information such as the detection results to the control unit 101.

The vehicle door open/close sensors 11 to 14 are sensors for detecting the open/closed states of the vehicle doors D1 to D4. The vehicle door open/close sensors 11 to 14 respectively correspond to the vehicle doors D1 to D4, and individually detect the respective open/closed states of the vehicle doors D1 to D4, and output signals indicating detection results. The vehicle door open/close sensors 11 to 14 may be switches that are turned ON or OFF according to whether the vehicle doors D1 to D4 are in a state of being open (an open state) or a state of being closed (a closed state), or sensors that detect the open state, the closed state, and an improperly closed state that is a state between the open state and the closed state, by detecting how much the vehicle doors D1 to D4 are open (the degree of opening).

The IG switch 15 is, for example, a push button type switch that starts up a drive source (e.g. an engine) of the vehicle C upon being pressed by the driver. The IG switch 15 is switched step by step to an OFF position, an accessory position (an ACC position), an ON position, and an engine start-up position, by being pressed by an occupant.

Generally, when the IG switch 15 is at the OFF position, a lamp control apparatus for controlling the headlights and so on, and a lock mechanism for locking the vehicle doors D1 to D4, for example, are enabled to operate, and when the IG switch 15 is at the ACC position, an audio output apparatus, a display apparatus, and so on (not shown) are enabled to operate. In this way, when the IG switch 15 is at the OFF position or the ACC position, only some low power consumption on-board devices can operate. In contrast, when the IG switch 15 is at the ON position, various on-board devices such as an air conditioning apparatus, turn signal/hazard warning lights, wipers, and meter devices, can operate. Furthermore, when the IG switch 15 is switched to the engine start-up position, the spark plug is caused to ignite to start up the engine, and returns to the ON position after starting up the engine.

The seat sensor 16 is a sensor for detecting a seating state of an occupant. The seat sensor 16 is, for example, provided in each of the seats of the vehicle C, such as the driver's seat, the passenger's seat, and the rear seats, and detects, for each seat, a seating state of the occupant, based on weight, pressure, or the like applied to the seat, and outputs a signal indicating a detection result.

The output unit 104 is provided with an interface for connecting the interior lights 21 to 24 and so on thereto. Upon receiving a control signal output from the control unit 101, the output unit 104 outputs the control signal to the interior lights 21 to 24, thereby turning ON or OFF the interior lights 21 to 24.

As described above, the interior lights 21 to 24 are light sources that respectively correspond to the vehicle doors D1 to D4. The interior lights 21 to 24 are subjected to lighting control performed by the control unit 101, and thus emit light in a lighting mode corresponding to the open/closed states of the vehicle doors D1 to D4 to notify an occupant sitting in the vehicle and an occupant who has got out of the vehicle C of the open/closed states of the vehicle doors D1 to D4.

The communication unit 105 is provided with a CAN (Controller Area Network) communication interface, for example, and is connected to another ECU (not shown) via a communication network such as a CAN. The communication unit 105 transmits/receives various kinds of data to/from another ECU according to a protocol such as a CAN protocol.

The following describes operations of the notification system according to the first embodiment.

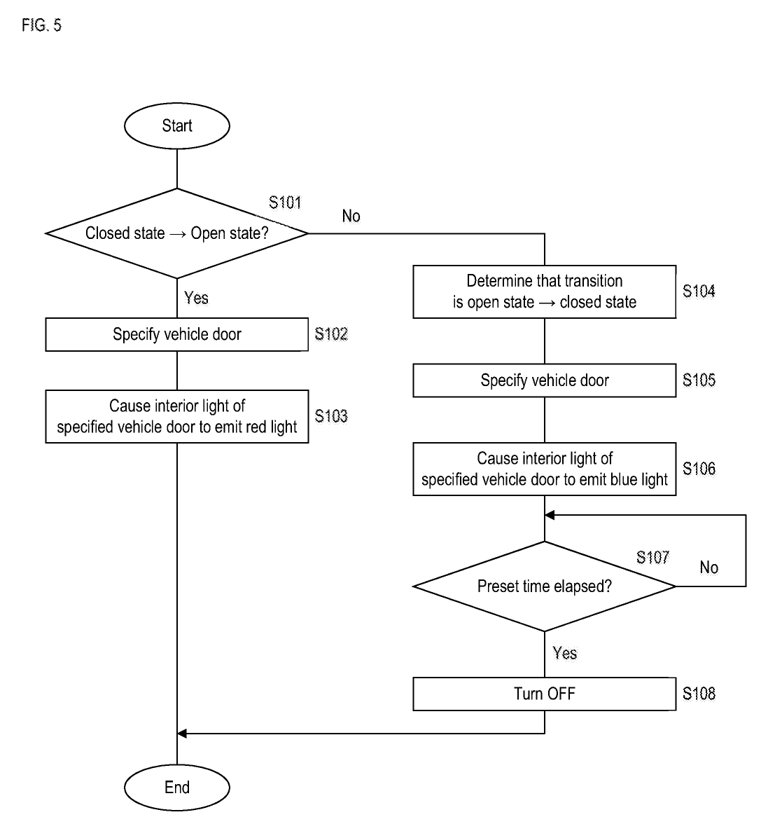

FIG. 5 is a flowchart illustrating processing procedures performed by the body ECU 100 according to the first embodiment. The control unit 101 of the body ECU 100 performs the following processing upon receiving, via the input unit 10, a detection signal output from the vehicle door open/close sensors 11 to 14.

The control unit 101 first determines whether or not the acquired detection signal is a signal that indicates a transition from the closed state to the open state of the vehicle doors D1 to D4 (step S101).

Upon determining that the signal indicates a transition from the closed state to the open state (S101: YES), the control unit 101 specifies a vehicle door (D1 to D4) that has transitioned from the closed state to the open state (step S102). If the output source of the acquired detection signal is the vehicle door open/close sensor 11 (12 to 14), the control unit 101 can specify the vehicle door D1 (D2 to D4) as the vehicle door that has transitioned from the closed state to the open state. Next, the control unit 101 outputs, from the output unit 104, a control signal that causes the interior light 21 (22 to 24) of the specified vehicle door D1 (D2 to D4) to emit red light, to cause the interior light 21 (22 to 24) to emit red light (step S103).

On the other hand, upon determining that the acquired detection signal is not a signal that indicates a transition from the closed state to the open state (S101: NO), the control unit 101 determines that the acquired detection signal is a signal that indicates a transition from the open state to the closed state (step S104), and specifies a vehicle door (D1 to D4) that has transitioned from the open state to the closed state (step S105). If the output source of the acquired detection signal is the vehicle door open/close sensor 11 (12 to 14), the control unit 101 can specify the vehicle door D1 (D2 to D4) as the vehicle door that has transitioned from the open state to the closed state. Next, the control unit 101 outputs, from the output unit 104, a control signal that causes the interior light 21 (22 to 24) of the specified vehicle door D1 (D2 to D4) to emit blue light, to cause the interior light 21 (22 to 24) to emit blue light (step S106).

Next, the control unit 101 refers to the built-in timer to determine whether or not a preset time (e.g. five seconds) has elapsed after outputting the control signal that causes the interior light 21 (22 to 24) to emit blue light (step S107). If the preset time has not elapsed (S107: NO), the control unit 101 waits until the preset time has elapsed.

Upon determining that the preset time has elapsed (S107: YES), the control unit 101 outputs, from the output unit 104, a control signal that turns OFF the interior light 21 (22 to 24), to turn OFF the interior light 21 (22 to 24) (step S108).

As described above, in the present embodiment, an open/closed state is detected for each of the vehicle doors D1 to D4, and the interior lights 21 to 24 can be caused to emit light in different lighting modes according to the detection results.

In the present embodiment, the control unit 101 is configured to, upon acquiring a detection signal output from the vehicle door open/close sensors 11 to 14, determine whether or not the signal indicates a transition from the closed state to the open state. However, the control unit 101 may be configured to determine whether or not the signal indicates a transition from the open state to the closed state. If this is the case, upon determining that the signal indicates a transition from the open state to the closed state, the control unit 101 performs the above-described processing in steps S105 to S108, and upon determining that the signal does not indicate a transition from the open state to the closed state, the control unit 101 determines that the acquired detection signal indicates a transition from the closed state to the open state, and performs the above-described processing in steps S102 and S103.

The following describes an example of lighting of the interior lights 21 to 24.

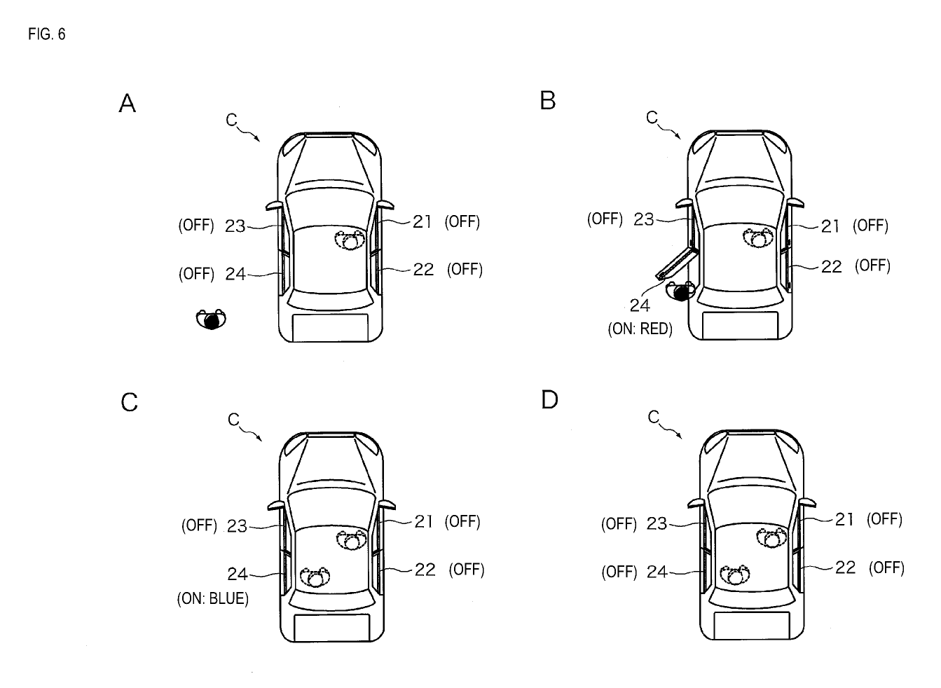

FIG. 6 is a diagram illustrating an example of lighting in a case where the driver is already in the vehicle and the vehicle door D4 has been properly opened and closed. FIG. 6A shows a state in which the driver has already got into the vehicle and all of the vehicle doors D1 to D4 are properly closed. In this case, all of the interior lights 21 to 24 are in an OFF state. FIG. 6B shows a state in which an occupant has opened the vehicle door D4 to sit on the left rear seat. The control unit 101 acquires a detection result indicating that the vehicle door D4 has transitioned from the closed state to the open state, and causes the interior light 24 to emit red light. FIGS. 6C and 6D show a state in which the vehicle door D4 is properly closed. In this case, the control unit 101 acquires a detection result indicating that the vehicle door D4 has transitioned from the open state to the closed state, causes the interior light 24 to emit blue light (FIG. 6C), and thereafter turns OFF the interior light 24 (FIG. 6D). By confirming that the color of the interior light 24 has changed from red to blue and thereafter the interior light 24 has turned OFF, the driver can determine that the vehicle door D4 is properly closed.

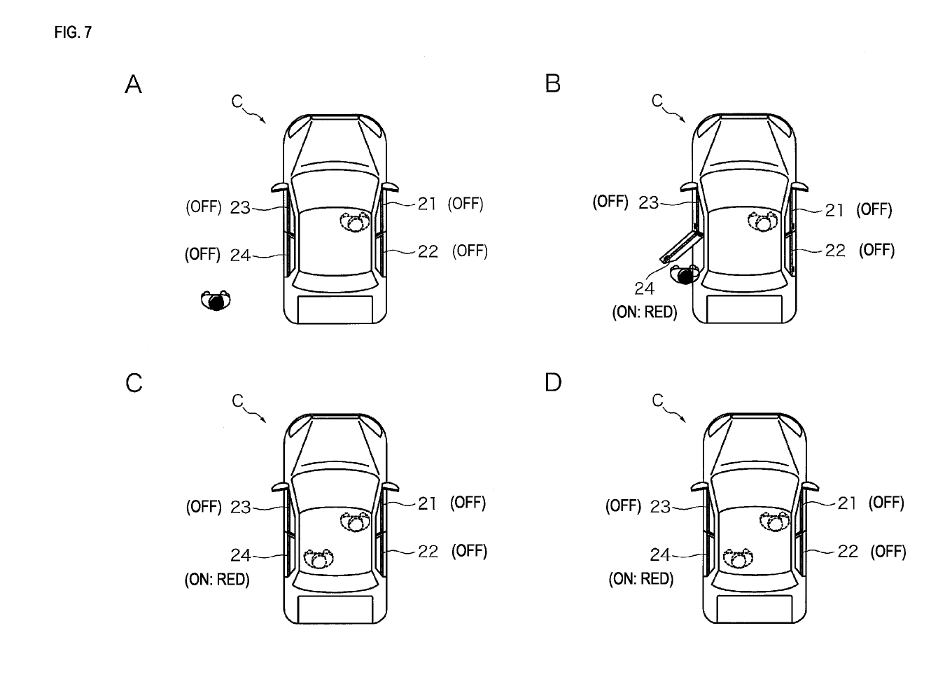

FIG. 7 is a diagram illustrating an example of lighting in a case where the vehicle door D4 has not been properly closed. FIG. 7A shows a state in which the driver has already got into the vehicle and all of the vehicle doors D1 to D4 are properly closed. In this case, all of the interior lights 21 to 24 are in an OFF state. FIG. 7B shows a state in which an occupant has opened the vehicle door D4 to sit on the left rear seat. The control unit 101 acquires a detection result indicating that the vehicle door D4 has transitioned from the closed state to the open state, and causes the interior light 24 to emit red light. FIGS. 7C and 7D show a state in which the vehicle door D4 has not been properly closed (an improperly closed state). In this case, the control unit 101 does not acquire a detection result indicating that the vehicle door D4 has transitioned from the open state to the closed state, and therefore the color of the light emitted from the interior light 24 does not change to blue, and the interior light 24 keeps emitting red light. By confirming that the color of the interior light 24 is still red, the driver can determine that the vehicle door D4 has not been properly closed (i.e. in an improperly closed state).

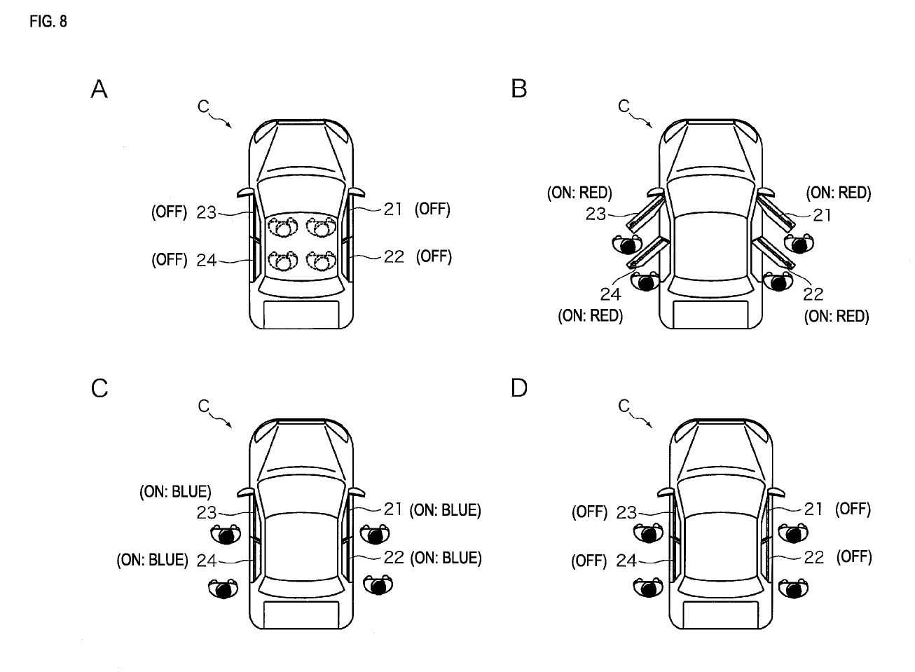

FIG. 8 is a diagram illustrating an example of lighting in a case where the vehicle doors D1 to D4 have been properly opened and closed when the occupants got out of the vehicle. FIG. 8A shows a state in which the occupants are sitting on the seats and all of the vehicle doors D1 to D4 are properly closed. In this case, all of the interior lights 21 to 24 are in an OFF state. FIG. 8 shows a state in which the occupants have opened the vehicle doors D1 to D4 to get out of the vehicle. The control unit 101 acquires detection results indicating that the vehicle doors D1 to D4 have transitioned from the closed state to the open state, and causes the interior lights 21 to 24 to emit red light. FIGS. 8C and 8D show a state in which the vehicle doors D1 to D4 are properly closed. In this case, the control unit 101 acquires detection results indicating that the vehicle doors D1 to D4 have transitioned from the open state to the closed state, causes the interior lights 21 to 24 to emit blue light (FIG. 8C), and thereafter turns OFF the interior lights 21 to 24 (FIG. 8D). By confirming that the color of the interior lights 21 to 24 has changed from red to blue and thereafter the interior lights 21 to 24 have turned OFF, the driver can determine that the vehicle doors D1 to D4 are properly closed.

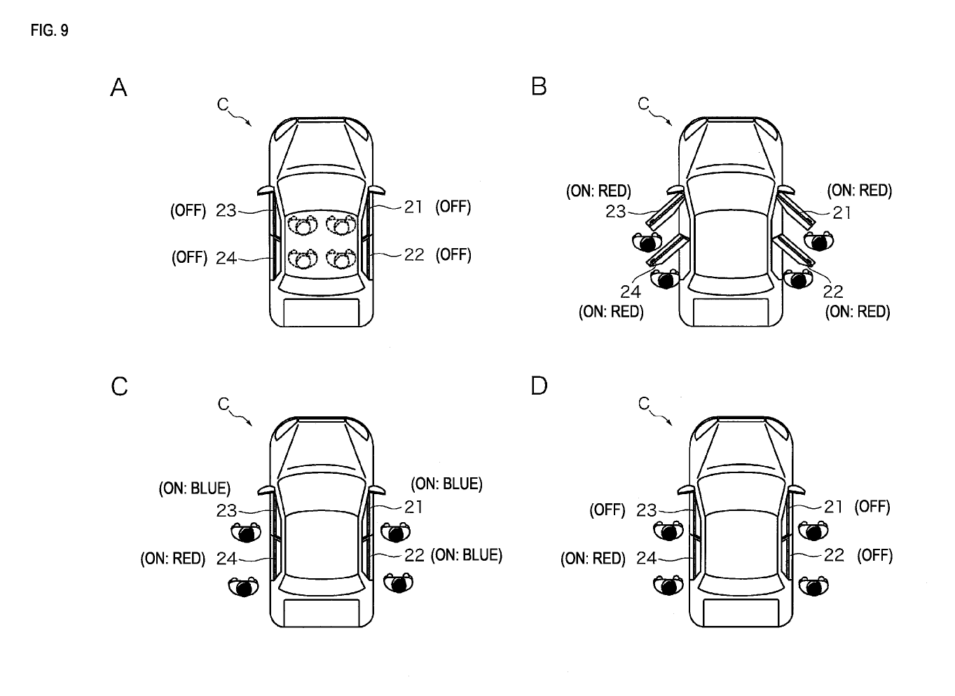

FIG. 9 is a diagram illustrating an example of lighting in a case where the vehicle door D4 has not been properly closed. FIG. 9A shows a state in which the occupants are sitting on the seats and all of the vehicle doors D1 to D4 are properly closed. In this case, all of the interior lights 21 to 24 are in an OFF state. FIG. 9 shows a state in which the occupants have opened the vehicle doors D1 to D4 to get out of the vehicle. The control unit 101 acquires detection results indicating that the vehicle doors D1 to D4 have transitioned from the closed state to the open state, and causes the interior lights 21 to 24 to emit red light. FIGS. 9C and 9D show a state in which the vehicle door D4 has not been properly closed (an improperly closed state). In this case, the control unit 101 acquires detection results indicating that the vehicle doors D1 to D3 have transitioned from the open state to the closed state, causes the interior lights 21 to 23 to emit blue light (FIG. 9C), and thereafter turns OFF the interior lights 21 to 23 (FIG. 9D). On the other hand, the control unit 101 does not receive a detection result indicating that the vehicle door D4 has transitioned from the open state to the closed state, and therefore the color of the light emitted from the interior light 24 does not change to blue, and the interior light 24 keeps emitting red light. By confirming that the color of the interior light 24 is still red, the driver can determine that the vehicle door D4 has not been properly closed (i.e. in an improperly closed state).

In the present embodiment, the interior lights 21 to 24 are respectively arranged at the lower ends of the inner sides of the window opening portions of the vehicle doors D1 to D4. Therefore, regardless of which seat an occupant is sitting on, and even when an occupant gets out of the vehicle C, the occupant can check the states of lighting of the interior lights 21 to 24, and confirm the open/closed states of the vehicle doors D1 to D4. Furthermore, it is unnecessary for an occupant to look up to check the lighting states of the interior lights 21 to 24. Therefore, it is possible to avoid a situation in which an occupant has difficulty in checking the lighting states due to sunlight interfering with the interior lights 21 to 24.

The present embodiment describes a lighting mode in which the interior lights 21 to 24 are caused to emit red light upon the vehicle doors D1 to D4 transitioning from the closed state to the open state, and the interior lights 21 to 24 are caused to emit blue light upon the vehicle doors D1 to D4 transitioning from the open state to the closed state, and thereafter the interior lights 21 to 24 are turned OFF. However, this is not the only lighting mode. For example, it is possible to employ a configuration in which the interior lights 21 to 24 are caused to emit light of another color, or a configuration in which the brightness of the interior lights 21 to 24 and the timing of turning ON and OFF the interior lights 21 to 24 are varied according to the open/closed states of the vehicle doors D1 to D4.

Also, the open state, the closed state, and the improperly closed state of the vehicle doors D1 to D4 may be separately detected, and upon the improperly closed state being detected, the interior lights 21 to 24 may be caused to emit light of another color, or control may be performed so that the interior lights 21 to 24 blink.

Furthermore, the lighting mode may be changed according to the result of detection by the seat sensor 16. For example, in a case where the vehicle C is provided with another display panel for notification of the open/closed states of the vehicle doors D1 to D4, and the driver can confirm the open/closed states of the vehicle doors D1 to D4 using the display panel, lighting control for the interior lights 21 to 24 may be omitted when the seat sensor 16 detects that the driver is sitting on the seat.

### Second Embodiment

The second embodiment describes an application example in which light-transmitting members with low transmittance, such as panes of privacy glass, are used as windows of the vehicle C.

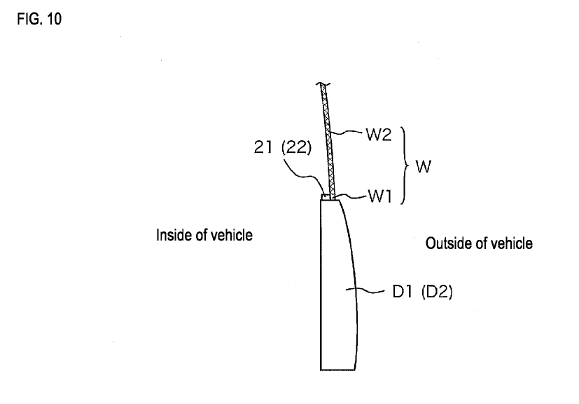

FIG. 10 illustrates an example of an arrangement of the interior light 21. FIG. 10 is a partially enlarged view of the vehicle door D1 seen in the thickness direction. As in the first embodiment, the interior light 21 is arranged at the lower end of the inner side of the window opening portion of the vehicle door D1. A window W that is provided in the window opening portion of the vehicle door D1 and separates the space inside the vehicle and the space outside the vehicle from each other has a first light-transmitting region W1 that is provided at the lower end of the window opening portion and a second light-transmitting region W2 that is located above the first light-transmitting region W1. The second light-transmitting region W2 is made from a light-transmitting member with low transmittance, and the first light-transmitting region W1 is made from a light-transmitting member with a transmittance higher than that of the second light-transmitting region W2. Note that the interior light 21 is arranged so as to face the first light-transmitting region W1.

Therefore, when sitting in the vehicle, an occupant can visually confirm the lighting state of the interior light 21. Furthermore, even if an occupant gets out of the vehicle C, the occupant can visually confirm the interior light 21 from the outside of the vehicle because light emitted from the interior light 21 passes through the first light-transmitting region W1.

Although the interior light 21 is described with reference to FIG. 10, the same description applies to the interior lights 22 to 24 and the windows of the vehicle doors D2 to D4.

The embodiment disclosed herein is to be considered as illustrative and non-limiting in all aspects. The scope of the present disclosure is indicated not by the above-stated meanings but by the scope of claims, and is intended to include all modifications that are within the meanings and the scope that are equivalent to those of the scope of claims.

1. A notification apparatus provided in a vehicle, the notification apparatus comprising:
a vehicle interior light configured such that some light emitted therefrom passes through a window of the vehicle from the inside of the vehicle to the outside of the vehicle;
a detection unit that detects an open/closed state of a door of the vehicle; and
a control unit that performs lighting control on the vehicle interior light such that the vehicle interior light emits light in a lighting mode corresponding to a result of detection by the detection unit,
wherein the notification apparatus notifies an occupant in and/or out of the vehicle, of the open/closed state of the door, using light emitted from the interior light.

2. The notification apparatus according to claim 1,
wherein the open/closed state of the door detected by the detection unit includes an open state in which the door is open and a closed state in which the door is closed, and
the control unit changes the lighting mode of the vehicle interior light depending on whether the detection unit detects the open state or the closed state of the door.

3. The notification apparatus according to claim 1,
wherein the open/closed state of the door detected by the detection unit includes an open state in which the door is open, a closed state in which the door is fully closed, and an improperly closed state that is a state between the open state and the closed state, and
the control unit changes the lighting mode of the vehicle interior light depending on whether the detection unit detects the open state, the closed state, or the improperly closed state of the door.

4. The notification apparatus according to claim 1,
wherein the vehicle interior light is provided for each of a plurality of doors of the vehicle, and
the control unit performs lighting control on the vehicle interior lights such that the vehicle interior lights emit light in different lighting modes according to detection results regarding the respective open/closed states of the doors.

5. The notification apparatus according to claim 1
wherein the vehicle interior light is arranged such that the light emitted therefrom passes through a plurality of windows that face each other in a width direction of the vehicle.

6. The notification apparatus according to claim 1,
wherein the vehicle interior light is arranged at the lower end of the inner side of a window opening portion of the door.

7. The notification apparatus according to claim 1,
wherein the window is constituted by a light-transmitting member provided with a first light-transmitting region that is provided at the lower end of the window and a second light-transmitting region that has lower transmittance than the first light-transmitting region and is provided above the first light-transmitting region, and
the vehicle interior light is arranged so as to face the first light-transmitting region.

8. The notification apparatus according to claim 1,
wherein the lighting mode relates to the color of light, the brightness thereof, and the timing of turning the vehicle interior light ON and OFF.
